(19) United States
(12) Patent Application Publication
(10) Pub. No.: US 2008/0182622 A1
(43) Pub. Date: Jul. 31, 2008

(54) Method and Apparatus for Implementing a SIM Card Onboard a PC Card

(75) Inventors: Brian Glenn Makarowski, San Marcos, CA (US); Kent Gawain Crandall, Carlsbad, CA (US)

Correspondence Address: THELEN REID BROWN RAYSMAN & STEINER LLP, P. O. BOX 640640, SAN JOSE, CA, 95164-0640, US

(73) Assignee: Sierra Wireless, Inc., Richmond (CA)

(21) Appl. No.: 11/698,410

(22) Filed: Jan. 25, 2007

(51) Int. Cl. H04M 1/00

(52) U.S. Cl. 455/558

(57) ABSTRACT

A method and device for providing wireless communication having a SIM card coupled to a Peripheral Component Interconnect (“PCI”) Card is disclosed. In one embodiment, the device includes a printed circuit board (“PCB”), a flex-circuit and a subscriber identity module (“SIM”) socket. The PCB further contains multiple input and output (“I/O”) contacts that are used for coupling the device to a system to facilitate wireless communication between the system and a wireless service provider. The flex-circuit includes a first side, a second sides, and a flexible connector. The second side of the flex-circuit is coupled to a first side of the PCB and the flexible connector is electrically connected to the PCB. The SIM socket is configured to receive or fit a SIM card on a first side of the SIM socket, wherein the second side of the SIM socket is coupled to the first side of the flex-circuit.

### FIELD OF THE INVENTION

The present invention relates to network communication. More specifically, the present invention relates to wireless communication using a radio component and a remote SIM card.

### BACKGROUND OF THE INVENTION

With increasing popularity of using the wireless communication to access Internet and World Wide Web (“the Web”), more devices such as laptop computers and handheld devices are incorporating wireless communication capabilities in their systems. A typical method to incorporate a wireless capability in a system is to incorporate a radio component, also known as a cellular phone component, together with a subscriber identity module (“SIM”) card. A conventional solution to include a radio component in a system is to use a PC card together with a SIM card wherein the PC card is typically used as a wireless modem. A conventional PC card uses PCMCIA (Personal Computer Memory Card International Association) protocol to communicate data between the PC card and the system. For example, a PC card that is configured to receive a SIM card can be plugged into a PCMCIA slot of a system to provide wireless communication for the system. Alternatively, a SIM card can be located in a system (also known as a remote area) independent from the location of the PC card in situations where the PC card does not have room to house the SIM card. The SIM card can also be disposed remotely from an embedded communications module in systems that that rely on such modules instead of pluggable or removable PC cards. The current industry specification allows a SIM card to be remotely located in a system from the embedded module and/or PC card and uses a standard I/O connector to communicate between the remote SIM card and the PC card and/or embedded module. A typical standard 10 connector uses PCMCIA I/O connections.

To incorporate a wireless component such as GSM capability in a system (or device), it typically requires the system manufacturers to perform extensive tests on both PC cards and SIM cards to comply with the industrial standards as well as the regulatory requirements. To comply with the industrial and regulatory requirements, a system manufacture typically has to purchase and incorporate a PC card (also known as wireless module or wireless modem) and a SIM card into its system. After prototyping a system with a PC card and a SIM card, the manufacture performs a required certification test to satisfy the industrial and regulatory requirements. Since a PC card and a SIM card are considered two independent components, the compliance certification tests often need to be conducted independently. As such, the typical process of incorporating a PC card and a SIM card in a system takes time and resources.

Accordingly, one problem associated with the conventional approach is the complexity of design for incorporating a PC card and a SIM card as two separate components in a system. Another problem associated with the conventional approach is performing the compliance test for a PC card and a SIM card independently, which takes time and resources.

Therefore, there is a need in the art to have a PC card including at least one SIM card that simplifies the design and the certification tests.

### SUMMARY OF THE INVENTION

The present invention discloses a technique to provide wireless communications using a SIM card onboard a PC card. A digital processing device such as a laptop computer includes a printed circuit board (“PCB”), a flex-circuit and a subscriber identity (“SIM”) socket. In one embodiment, the PCB is a component of a PC card and the SIM socket is configured to receive a SIM card. The PCB further contains multiple input and output (“I/O”) contacts used for coupling between the PCB and the digital processing device for communication. The flex-circuit, in one embodiment, is a flexible circuit board including a flexible connector. In one embodiment, the bottom surface of the flex-circuit is physically contacted to the top surface of the PCB. The flexible connector is electrically connected to the PCB. In another embodiment, the flexible connector is directly coupled to the device. The top surface of the SIM socket is configured to receive a SIM card while the bottom surface of the SIM socket is coupled to the top surface of the flex-circuit.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a wireless communication system in accordance with one embodiment of the present invention;

FIG. 2 is a block diagram illustrating a computer and a SIM card onboard a PCI card in accordance with one embodiment of the present invention;

FIG. 3 is a block diagram illustrating a side view of a device having a SIM card onboard a PC card in accordance with one embodiment of the present invention;

FIG. 4 is a block diagram illustrating a side view of a device having a SIM card onboard a PC card in accordance with another embodiment of the present invention;

FIG. 5 illustrates a device having a SIM socket onboard a PC card in accordance with one embodiment of the present invention;

FIG. 6 is a flowchart illustrating a process of providing a wireless communication in accordance with one embodiment of the present invention; and

FIG. 7 is a block diagram illustrating a digital processing device 700 coupled with a PC card 704 having multiple onboard SIM cards in accordance with one embodiment of the present invention.

### DETAILED DESCRIPTION

A method and device for providing wireless communication using a SIM card onboard a PC card are disclosed. It should be noted that the PC card could be a Peripheral Component Interconnect (“PCI”)-Express Mini Card, a PCI card, a Data card, a PCMCIA (Personal Computer Memory Card International Association) card, or the like.

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice to present invention. In other instances, well- known circuits and devices are shown in block diagram form to avoid obscuring the present invention. In the following description of the embodiments, substantially the same parts are denoted by the same reference numerals.

It is understood that the present invention may contain transistor circuits, chip packaging, and circuit board technology that are readily manufacturable using well-known art, such as for example CMOS (“complementary metal-oxide semiconductor”) technology, or other semiconductor manufacturing processes. In addition, the present invention may be implemented with other manufacturing processes for making digital devices.

The present invention discloses a technique to provide wireless communication having a SIM card onboard a PC card. A digital processing device includes a printed circuit board (“PCB”), a flex-circuit and a subscriber identity (“SIM”) socket. The digital processing device can be a laptop computer, a personal digital assistant, a mobile phone, a personal computer, a server, a workstation, a mini-computer, or a mainframe computer. In one embodiment, the PCB is a PC card and the SIM socket is configured to receive a SIM card. The PCB further contains multiple input and output (“I/O”) contacts used for coupling between the PCB and the digital processing device for facilitating wireless communication. The flex-circuit, in one embodiment, is a flexible circuit board including a flexible connector. The bottom surface of the flex-circuit is coupled to the top surface of the PCB and the flexible connector is electrically connected to the PCB. In another embodiment, the flexible connector can be directly coupled to the device. The top side of the SIM socket is configured to receive a SIM card while the bottom side of the SIM socket is coupled to the top surface of the flex-circuit.

A SIM card, in one embodiment, is plugged or inserted into the SIM socket to facilitate wireless communication between the device and a remote device across a wireless network, such as Verizon wireless or Cingular wireless network. The SIM card includes information relating to a mobile subscriber, telephone number, location area identity, and numbers required by a network to recognize and authenticate the mobile subscriber. In another embodiment, the SIM card is a Universal Subscriber Identity Module (“USIM”). In yet another embodiment, the PC card is configured to control multiple SIM cards wherein some of the SIM cards are physically located on the PC card while other SIM cards are located remotely.

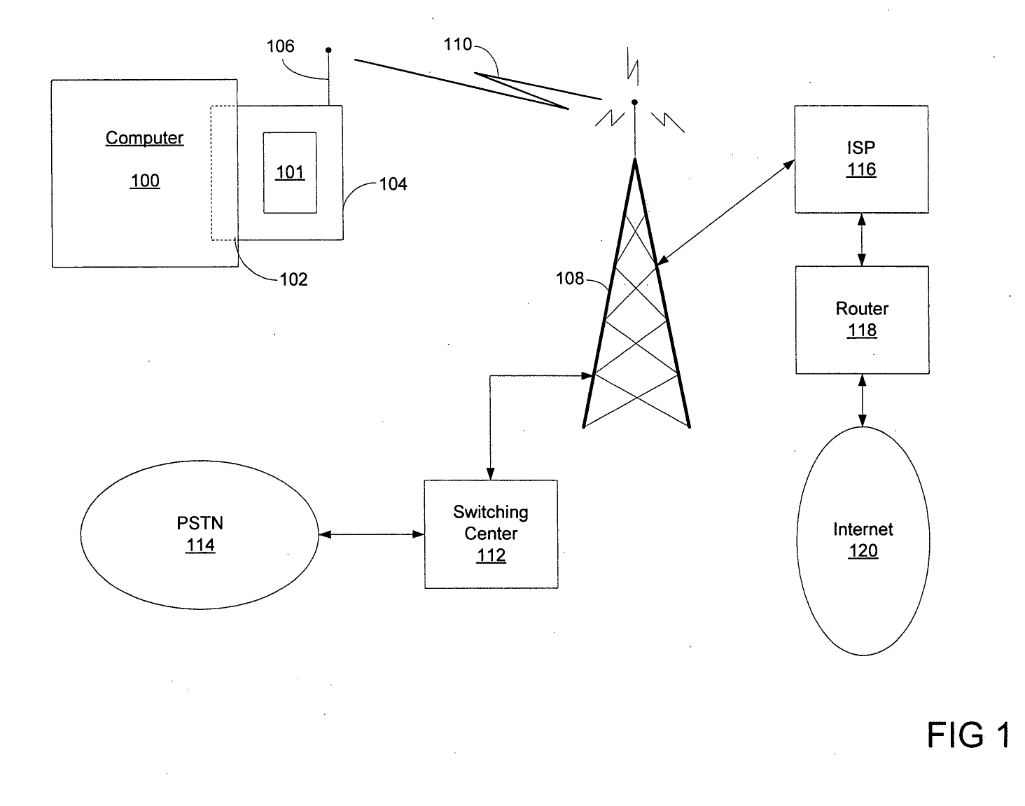

FIG. 1 is a block diagram illustrating a wireless communication system in accordance with one embodiment of the present invention. A computer 100 includes a slot 102 and a PC card 104. In one embodiment, slot 102 is configured to receive PC card 104 using the PCMCIA (Personal Computer Memory Card International Association) standard for data communication between PC card 104 and computer 100. PC card 104, also referred to as a PCMCIA card or Data Card, is connected to computer 100 and functions as a wireless modem. An advantage of having a PC card 104 in a laptop is allowing a user to access on-line services while the user is moving such as in a bus or a car. For example, a user can send and receive data, e-mail and also browse the Internet after a wireless connection is established between PC card 104 and a wireless network. PC card 104, in one embodiment, includes a SIM card 101 and an antenna 106 that is used for transmitting RF (radio frequency) signals modulated by data, voice and video information to/from a base station 108 over a wireless link 110.

Base station 108 transmits or receives voice modulated signals to or from a mobile switching center 112. Switching center 112 further communicates with a remote device (e.g. a telephone and/or a gateway device) over the PSTN 114 (Public Switched Telephone Network). Base station 108 is also coupled to an ISP (Internet Service Provider) Server 116 for transmitting/receiving data modulated signals. ISP server 116 transmits/receives data to/from a gateway or router 118, which further sends/receives the data to/from a remote device over the Internet 120.

Referring back to FIG. 1, base station 108 is capable of being associated with multiple networks. For example, it may be associated with a pager network or a wireless communications network used by cellular telephones. One particular cellular telephone network may provide GSM (Global System for Mobile communications) services. Besides functioning as a voice network, GSM is becoming particularly attractive to developers of wireless-communication-enabled computers. A reason for this is that GSM supports packet-switched data protocols like GPRS (General Packet Radio Service). Packet-switched data makes more efficient use of available bandwidth and is faster than traditional circuit-switched data protocols. GPRS also supports the Internet Protocol (IP), thereby allowing users of a computing device with a GPRS-compatible PC card wireless modem to gain access to the Internet.

PC card 104, in one embodiment, is a PCI-Express MiniCard, which includes an onboard SIM card 101. SIM card 101 is an electronic card, which includes a SIM chip, and is configured to be physically fitted on top of PC card 104. SIM card 101 contains information such as a network identification number (“ID”) for network subscription and is used to request network services. In one aspect, SIM card 101 further contains status information such as its current location area identity (“LAI”). A function of LAI is to restore the wireless connection after the connect was temporarily disconnected. It should be noted that PC card 104 can be any type of form factor such as PCI-Express MiniCard, Mini PCI card, UMTS (Universal Mobile Telecommunications System) PCI x-m card, and so forth.

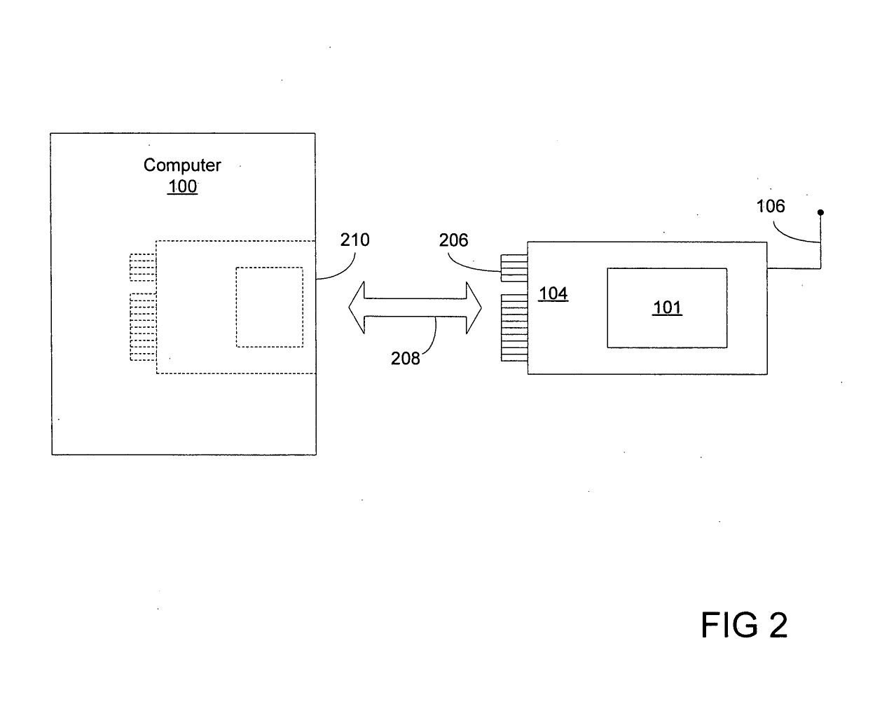

FIG. 2 is a block diagram illustrating a host computer 100 and a SIM card 101 onboard a PC card 104 in accordance with one embodiment of the present invention. PC card 104, which is also referred to a PC card wireless modem, includes an antenna 106 for transmitting/receiving radio frequency (RF) signals to/from remote devices over a wireless network. PC card 102, in one embodiment, uses the network ID stored in SIM card 101 to facilitate wireless communication between host computer 100 and remote devices such as computers and servers over a wireless network.

PC card 104, in one embodiment, is a PCI-Express MiniCard that includes various input/output (“I/O”) contacts 206, which are arranged in accordance with the PCMCIA standard. Computer 100 communicates with PC card 104 via a PCMCIA interface 208, when terminals 206 are plugged into PCMCIA slot 210 of computer 100. PCMCIA interface 208 not only provides a communication means, it also includes power and ground terminals that couple a power supply of computer 100 to the power and ground terminals of PC card 104 including SIM card 101. It should be noted that PC card 104 can be any types of card that contains embedded modules capable of implementing GSM, GPRS (General Packet Radio Service), TDMA (Time Division Multiple Access) or any types of radio frequencies capable of performing wireless communications.

Computer 100, in one embodiment, includes a processing unit, an interface bus, and an input/output (“I/O”) unit. The processing unit includes a processor, a main memory, a system bus, a static memory device, a bus control unit, and a mass storage memory. The system bus is used to transmit information between various components and processor for data processing. The processor may be any of a wide variety of general-purpose processors or microprocessors such as Pentium microprocessor, Motorola™ 68040, or Power PC™ microprocessor. An I/O unit includes a display, keyboard, cursor control device, and communication device. The display device may be a liquid crystal device, cathode ray tube (“CRT”), touch-screen display, or other suitable display device.

The present invention includes various processing steps, which will be described below. The steps of the present invention may be embodied in machine or computer executable instructions. The instructions can be used to cause a general purpose or special purpose system, which is programmed with the instructions to perform the steps of the present invention. Alternatively, the steps of the present invention may be performed by specific hardware components that contain hard-wired logic for performing the steps, or by any combination of programmed computer components and custom hardware components. While embodiments of the present invention will be described with reference to the Internet, the method and apparatus described herein is equally applicable to other network infrastructures or other data communications environments.

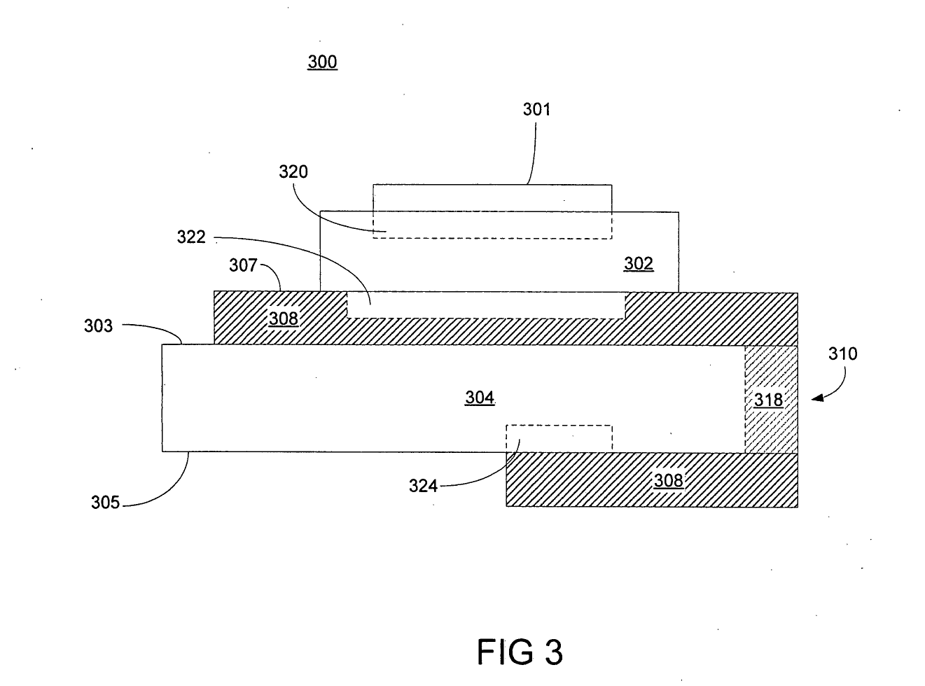

FIG. 3 is a side view block diagram illustrating a device 300, which includes a SIM card onboard a PC card, in accordance with one embodiment of the present invention. Device 300 includes a printed circuit board (“PCB”) 304, a flex-circuit 308, a SIM socket 302, and a SIM card 301. In one embodiment, PCB 304 is a printed circuit board of a PC card. In another embodiment, PC card is a PCI-Express MiniCard or a UMTS PCI x-m card. It should be noted that PCB 304 includes multiple I/O contacts (not shown in FIG. 3), which are used to inserted into a slot of system or a laptop, for providing communication between PCB 304 and the system. It should be further noted that there could have more components such as control circuitry, memory devices, drivers, antenna(s), et cetera on PCB 304.

Flex-circuit 308 is coupled to the top surface 303 (or first side) of PCB 304 and wraps around at a cutout edge 310 of PCB 304. A portion 318 of flex-circuit 308 wraps around the edge 310 of PCB 304. In one embodiment, flex-circuit 308 is connected to PCB 304 at the bottom surface 305 (or second side) of PCB 304. A flexible connector of flex-circuit 308 is used to connect or snap onto a place with small contacts 324 located at the bottom surface 305 of PCB 304. The flexible connector, as a second or alternative I/O connector of the PC card, provides an alternative channel to communication to the system instead of standard I/O contacts 206 as shown in FIG. 2. In one embodiment, the flexible connector of flex-circuit 308 is configured to connect to PCB 304. In another embodiment, the flexible connector is configured to connect to the system. Flex-circuit 308 is adhesively applied to the top surface 303 of PCB 304. In another embodiment, flex-circuit 308 is configured to support multiple SIM cards.

SIM socket 302 is coupled to the top surface 307 of flex-circuit 308. In one embodiment, SIM socket 302 is adhesively applied to the top surface 307 of flex-circuit 308. SIM socket 302 is electrically connected to flex-circuit 308 via a contact pad 322. SIM socket 302 includes a standard SIM card locking mechanism, which is used to lock SIM card 301 with SIM socket 302. The locking mechanism of SIM socket 302 is configured to allow a SIM card to be removable from SIM socket 302. In one embodiment, half of SIM card 301 is submerged into SIM socket 302 after SIM card 301 is inserted into SIM socket 302. In another embodiment, the entire SIM card 301 is submerged inside SIM socket 302. In yet another embodiment, SIM card 301 sits on the top of SIM socket 302.

In one aspect, flex-circuit 308, which contains a SIM card 301, can be customized for each application. For example, to integrate a PC card into a system, flex-circuit 308 can be customized to make the PC card compatible with the system. An advantage of having a SIM card onboard a PC card is to simplify the design and reduce the burden of industrial certification tests because a PC card having an onboard SIM card can be treated as one component. In one embodiment, a PC card having device 300 is configured to communicate to a remote SIM card coupled to the system.

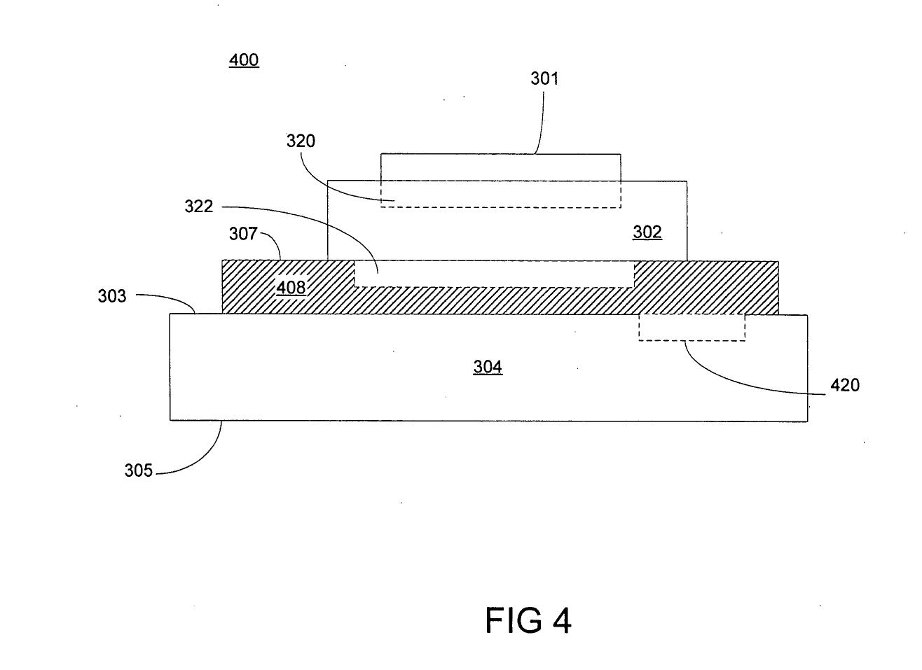

FIG. 4 is a side view of a block diagram illustrating a device, which includes a SIM card onboard a PCI card, in accordance with another embodiment of the present invention. Device 400 includes a PCB 304, a flex-circuit 408, a SIM socket 302, and a SIM card 301. In one embodiment, PCB 304 is a printed circuit board of a PC card. The PC card, in one embodiment, is a PCI-Express MiniCard or a UMTS PCI x-m card. It should be noted that PCB 304 includes multiple I/O contacts (not shown in FIG. 4) for providing communication between PCB 304 and the system. It should be noted that there could be more components such as control circuitry, memory devices, drivers, antenna(s), et cetera on PCB 304.

Flex-circuit 408 is coupled to the top surface 303 (or first side) of PCB 304. A flexible connector of flex-circuit 408 is used to connect to a small contact 420 located at the top surface 303 of PCB 304. The flexible connector provides an alternative connecting capability to the system instead of using the standard I/O contacts 206 as shown in FIG. 2. In one embodiment, the flexible connector of flex-circuit 408 can be configured to either connect to PCB 304 or the system. Flex-circuit 408, in one aspect, is adhesively applied to the top surface 303 of PCB 304. In another embodiment, flex-circuit 408 is configured to support multiple SIM cards.

SIM socket 302 is coupled to the top surface 307 of flex-circuit 408. In one embodiment, SIM socket 302 is adhesively applied to the top surface 307 of flex-circuit 408. SIM socket 302 is logically connected to flex-circuit 408 via a contact pad 322. SIM socket 302 includes a SIM card locking mechanism, which is used to lock SIM card 301 to SIM socket 302. The locking mechanism of SIM socket 302 is configured to allow a SIM card to be removed from or inserted into SIM socket 302. In one embodiment, half of the SIM card 320 is submerged into SIM socket 302 after SIM card 301 is inserted into SIM socket 302.

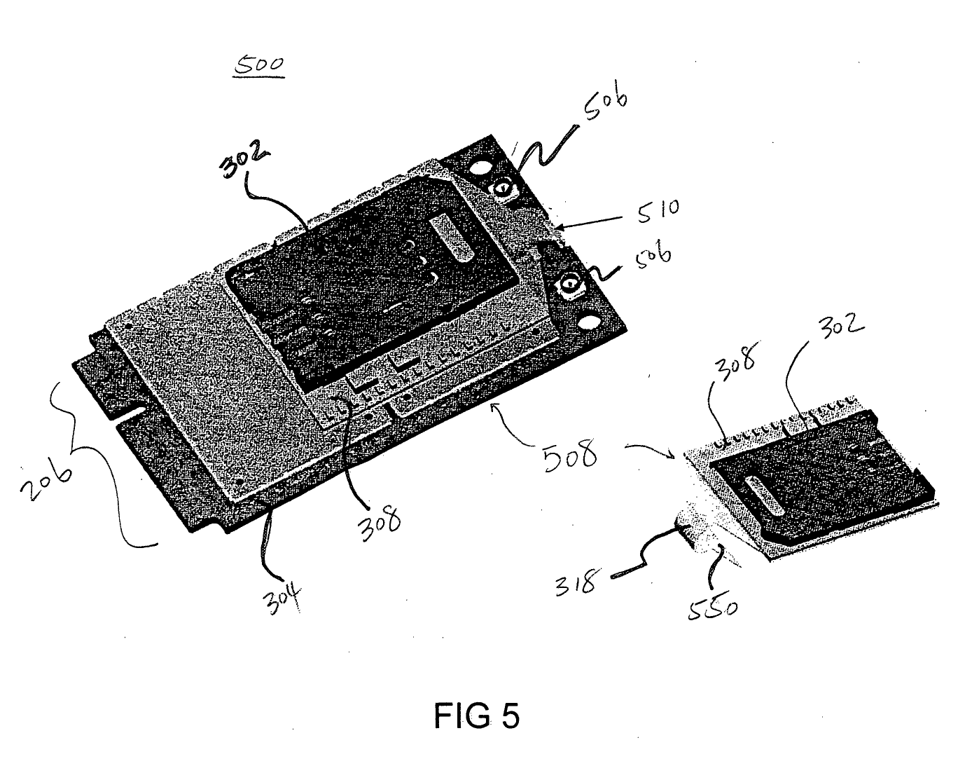

FIG. 5 illustrates a device 500 having a SIM socket onboard a PCI card and a flex-circuit having a SIM socket 508 in accordance with one embodiment of the present invention. Device 500 includes a PCB 304, a flex-circuit 308, and a SIM socket 302. In one embodiment, PCB 304 is a printed circuit board of a PC card. It should be noted that PCB 304 includes multiple I/O contacts 206, which are used to inserted into a slot of system. It should be further noted that there could have other components such as control circuitry, memory devices, drivers, antenna(s), et cetera attached and/or embedded PCB 304.

Flex-circuit 308 is physically coupled to the top surface of PCB 304. Flex-circuit 508 shows a flexible circuit before it is coupled to a printed circuit board. A portion 318 of flex-circuit 308 wraps around a cutout in the edge 510 of PCB 304 and a flexible connector 550 of flex-circuit 308 is connected to the bottom surface of PCB 304. The present invention allows the PC card to communicate with a SIM card either through the standard I/O connector 206 or flexible connector 550 of flex-circuit 308.

SIM socket 302 is coupled to a top surface of flex-circuit 308. In one embodiment, SIM socket 302 is adhesively applied to the top surface of flex-circuit 308. SIM socket 302 is logically connected to flex-circuit 308. SIM socket 302 includes a SIM card locking mechanism, which is used to lock SIM card to SIM socket 302. The locking mechanism of SIM socket 302 is configured to allow a SIM card to be removed from SIM socket 302. In one embodiment, half of the SIM card 320 is submerged into SIM socket 302 after SIM card is inserted into SIM socket 302.

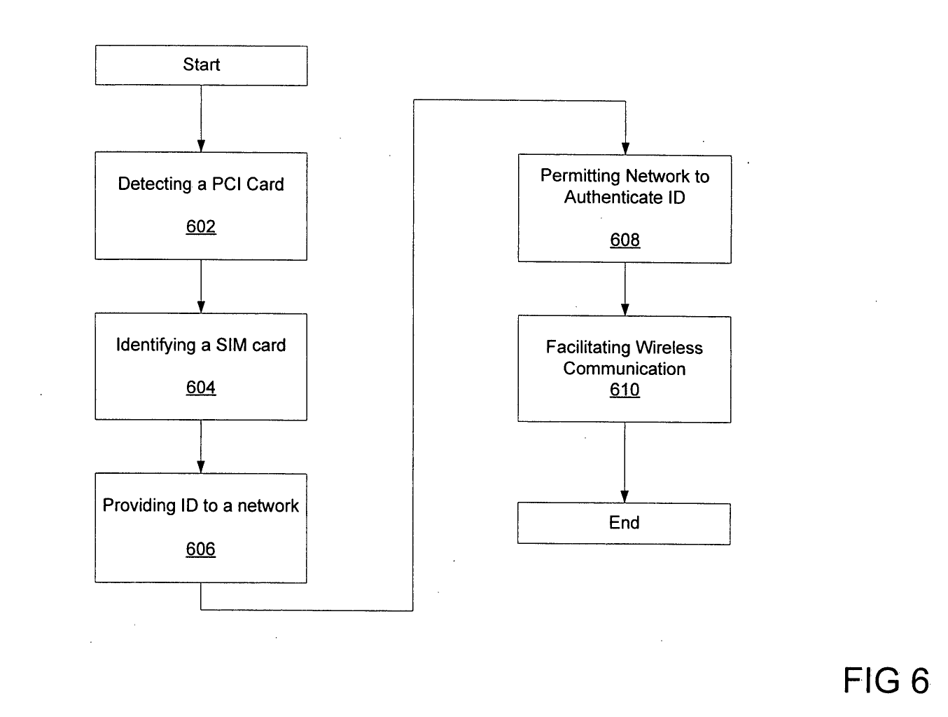

FIG. 6 is a flowchart illustrating a process of providing a wireless communication in accordance with one embodiment of the present invention. At block 602, the process detects a removable PCI card that is coupled to a computer. In one embodiment, the PCI card is a PCI-Express Mini Card. In another embodiment, the PCI card uses the PCMCIA standard protocol for data communication. In another embodiment, a computer is a laptop computer. In yet another embodiment, a computer is any digital processing devices that are capable of executing instruction. After block 602, the process moves to the next block.

At block 604, the process identifies a SIM card that is couple to a surface of the removable PC card. In one embodiment, the process is capable to detecting multiple SIM cards including SIM cards onboard PC card as well as remote SIM cards, which can be anywhere in the computer. After block 604, the process moves to the next block.

At block 606, the process fetches an ID (identifier) of a mobile subscription stored in the SIM card and provides the ID of the mobile subscription to a wireless network. If multiple SIM cards are detected, the process is capable of identifying which SIM card information should be used for requesting wireless network services in response to the availability of the wireless services at the location of the system. After block 606, the process proceeds to block 608.

At block 608, the process permits the network to authenticate the mobile subscriber ID. In one embodiment, if a submitted ID number is rejected, the process is capable of submitting another ID number if multiple SIM cards are detected. After block 608, the process moves to block 610.

At block 610, the process facilitates wireless communications between the system and a wireless service provider through the SIM card information. In one embodiment, if the connection is terminated, the process uses information stored in the SIM card to reconnect to the network. After block 610, the process ends.

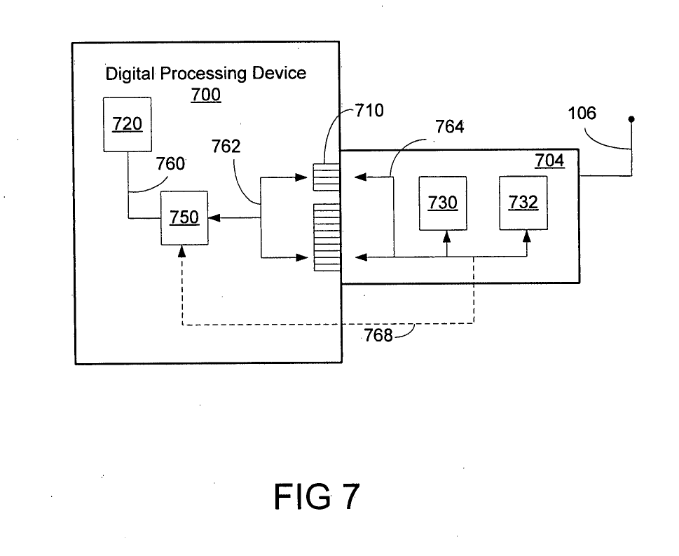

FIG. 7 is a block diagram illustrating a digital processing device 700 coupled with a PC card 704 having multiple onboard SIM cards in accordance with one embodiment of the present invention. Digital processing device 700 includes a controller 750, a remote SIM card 720 and I/O contacts 710. PC card 704 is coupled to digital processing device 700 via I/O contacts 710 and is configured to have two onboard SIM cards 730-732. It should be obvious to one skilled in the art that digital processing device 700 and PC card 704 may contain additional SIM cards as well as other components.

PC card 704 communicates with remote SIM card 720 via controller 750. In one embodiment, the remote SIM card 720 forward information to/from controller 750 via bus 760. Controller 750 subsequently passes the information to PC card 704 through bus 762. Similarly, PC card 704 communications with onboard SIM cards 730-732 via bus 764. In another embodiment, PC card 704 communicates with onboard SIM cards 730-732 via I/O contacts 710 if onboard SIM cards 730-732 are directly coupled to digital processing device 700 via 768 using a flexible connector.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

What is claimed is:

1. A device for providing wireless communication comprising:
a printed circuit board (“PCB”) having input and output (“I/O”) contacts for coupling to a system and configured to provide wireless communication;
a flex-circuit having a first surface, a second surface, and a flexible connector, wherein the second surface of the flex-circuit is coupled to a first side of said PCB, wherein the flexible connector is electrically coupled to the PCB; and
a subscriber identity module (“SIM”) socket, having a first side and a second side, configured to receive a SIM card on the first side of the SIM socket, wherein the second side of the SIM socket is coupled to the first side of the flex-circuit.

2. The device of claim 1, further comprising a SIM card plugged in the SIM socket and configured to facilitate wireless communication between the system and a network service provider.

3. The device of claim 2, wherein the SIM card includes information relating to a mobile subscriber, telephone number, location area identity, and numbers required by a network to recognize and authenticate the mobile subscriber.

4. The device of claim 3, wherein the SIM card is a Universal Subscriber Identity Module (“USIM”).

5. The device of claim 1, wherein the wireless communications include data, voice, and video information.

6. The device of claim 5, wherein the PCB further includes an antenna for receiving and transmitting information between the system and a network service provider.

7. The device of claim 6, wherein the system is one of a personal digital assistant, a mobile phone, a personal computer, a server, a workstation, a mini-computer, and a mainframe computer.

8. The device of claim 1, wherein the flexible connector is electrically connected to the PCB further includes the flexible connector wraps around the PCB and is connected to a PCB connector located on the second side of the PCB.

9. The device of claim 1, further includes a control circuit coupled to the PCB and configured to identify number of SIM cards logically coupled to the system.

10. A method for providing a wireless communication, comprising:
detecting a removable peripheral component interconnect (“PCI”) card that is coupled to a computer;
identifying a subscriber identity module (“SIM”) card couple to a surface of the removable PCI card;
providing identification number (“ID”) of a mobile subscriber stored in the SIM card to a network;
permitting the network to authenticate the mobile subscriber ID; and
facilitating wireless communication between the system and a wireless service provider through the SIM card.

11. The method of claim 10, further comprising:
identifying a remote SIM card on the system; and
activating one of the remote SIM card or the SIM card located on the removable PCI card.

12. The method of claim 10, Wherein activating one of the remote SIM card and the SIM card located on the removable PCI card further includes:
identifying geographical location of the system;
determining local service providers for the geographical location; and
activating one of the two SIM cards that is recognized by the local service providers.

13. The method of claim 10, wherein the detecting a removable peripheral component interconnect (“PCI”) card further includes identifying PCI-Express MiniCard.

14. The method of claim 10, further comprising allowing a user to customize the SIM card.

15. An apparatus for providing a wireless communication, comprising:
means for detecting a removable peripheral component interconnect (“PCI”) card that is coupled to a computer;
means for identifying a subscriber identity module (“SIM”) card couple to a surface of the removable PCI card;
means for providing identification number (“ID”) of a mobile subscriber stored in the SIM card to a network;
means for permitting the network to authenticate the mobile subscriber ID; and
means for facilitating wireless communication between the system and a wireless service provider through the SIM card.

16. The apparatus of claim 15, further comprising:
means for identifying a remote SIM card on the system; and
means for activating one of the remote SIM card or the SIM card located on the removable PCI card.

17. The apparatus of claim 15, Wherein means for activating one of the remote SIM card and the SIM card located on the removable PCI card further includes:
means for identifying geographical location of the system;
means for determining local service providers for the geographical location; and
means for activating one of the two SIM cards that is recognized by the local service providers.

18. The apparatus of claim 15, wherein the means for detecting a removable peripheral component interconnect (“PCI”) card further includes means for identifying PCI-Express MiniCard.

19. The apparatus of claim 10, further comprising means for allowing a user to customize the SIM card.

20. A device for providing wireless communication comprising:
a peripheral component interconnect (“PCI”)-Express MiniCard having a plurality of input and output (“I/O”) contacts for coupling to a digital processing system utilizing PCMCIA protocol and configured to provide wireless communication;
a flex-circuit having a first surface, a second surface, and a flexible connector, wherein the second surface of the flex-circuit is coupled to a first surface of the PCI-Express MiniCard, wherein the flex-circuit is logically connected to the PCI-Express MiniCard; and
a subscriber identity module (“SIM”) socket, having a first surface and a second surface, configured to receive a SIM card on the first surface of the SIM socket, wherein the second surface of the SIM socket is coupled to the first surface of the flex-circuit.

21. The device of claim 20, wherein the flex-circuit is logically connected to the PCI-Express MiniCard further includes a flexible connector of the flex-circuit is coupled to the second side of PCI-Express MiniCard.

22. The device of claim 20, wherein the flex-circuit is logically connected to the PCI-Express MiniCard further includes a flexible connector of the flex-circuit is coupled to the digital processing system wherein the flex-circuit is communicated with the PCI-Express MiniCard via I/O contacts of the PCI-Express MiniCard.

23. The device of claim 22, wherein the digital processing system is a laptop computer.

24. A digital processing system comprising:
a digital processing device;
a PC card couple to the digital processing device; wherein the PC card further includes:
a printed circuit board (“PCB”) having input and output (“I/O”) contacts for coupling to a system and configured to provide wireless communication;
a flex-circuit having a first surface, a second surface, and a flexible connector, wherein the second surface of the flex-circuit is coupled to a first side of said PCB;
a subscriber identity module (“SIM”) socket, having a first side and a second side, configured to receive a SIM card on the first side of the SIM socket, wherein the second side of the SIM socket is coupled to the first side of the flex-circuit; and
a remote SIN card coupled to the digital processing device and configured to provide network identification data in response to request of the digital processing device.

25. The system of claim 24 further comprising a SIM card inserted in the SIM socket and configured to facilitate wireless communication between the system and a network service provider.

26. The system of claim 25, wherein the SIM card includes information relating to a mobile subscriber, telephone number, location area identity, and numbers required by a network to recognize and authenticate the mobile subscriber.

27. The system of claim 26, wherein the SIM card is a Universal Subscriber Identity Module (“USIM”).

28. The system of claim 25, wherein a flexible connector of the flex-circuit is connected to the PCB.

29. The system of claim 25, wherein a flexible connector of the flex-circuit is connected to the digital processing device.
